(19) United States
(12) Patent Application Publication
(10) Pub. No.: US 2010/0002279 A1
(43) Pub. Date: Jan. 7, 2010

(54) MOVABLE BODY APPARATUS, OPTICAL DEFLECTOR, OPTICAL INSTRUMENT USING THE OPTICAL DEFLECTOR, AND RESONANCE FREQUENCY DETECTING METHOD

(75) Inventor: Kunitoshi Aoki, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/493,525

(22) Filed: Jun. 29, 2009

(30) Foreign Application Priority Data
Jul. 2, 2008 (JP) 2008-173324

(51) Int. Cl. G02B 26/08; G01N 29/12

(52) U.S. Cl. 359/224.1; 73/579

(57) ABSTRACT

A movable body apparatus includes an oscillatory system, a driving portion for driving the oscillatory system with a driving signal, a detecting portion for detecting an oscillating condition of the movable body, a storing portion, and an obtaining portion. The oscillatory system includes at least a movable body, and an elastic support portion for supporting the movable body in a swingingly rotatable manner. The storing portion stores data of frequency characteristics of maximum angular displacement based on maximum angular displacements of the movable body corresponding to plural driving frequencies, detected by the detecting portion. The obtaining portion obtains a resonance frequency of the oscillatory system by fitting to the data of frequency characteristics of maximum angular displacement stored in the storing portion, using a least squares method.

### BACKGROUND OF THE INVENTION

1. Field of the Invention

The present invention relates to a movable body apparatus including an oscillatory system with a movable body supported in a swingingly rotatable manner, and a method of detecting the resonance frequency of a oscillatory system. Particularly, the present invention relates to a movable body apparatus, an optical deflector using the movable body apparatus, and a method of detecting the resonance frequency of an oscillatory system in the movable body apparatus. More specifically, the present invention relates to, for example, an image forming apparatus of an electro-photography type in which the resonance frequency of a MEMS (Micro Electro Mechanical Systems) mirror is detected or obtained to control a driving frequency of the MEMS mirror based on the detected frequency, and a method of detecting the resonance frequency of a MEMS mirror. The optical deflector can be preferably used in optical instruments in which a light beam is deflected and scanned, such as bar code readers, image displaying apparatuses like a scanning-type display, and image forming apparatuses like a laser beam printer (LBP) and a digital copying machine.

2. Related Background Art

In recent years, further reduction of size and cost of an electro-photography image forming apparatus is required. In order to achieve such reduction, there has been proposed a method of using a galvano-mirror produced by semiconductor producing techniques in place of a conventional rotary polygonal mirror (see U.S. Pat. No. 5,606,447). In this method, the galvano-mirror is oscillated at its resonance frequency to scan laser light in a main scanning direction and form an image. The size of the galvano-mirror can be reduced by using semiconductor producing techniques. Further, the cost can also be reduced since a large number of galvano-mirrors can be manufactured at a time.

Further, in a mirror supported by serially-connected movable bodies, there are characteristics that an angular velocity in its oscillation range corresponding to a laser light scanning region can be made approximately constant by using a driving signal composed of appropriately synthesized sine-waves, and that its scanning angle can be increased (see U.S. Pat. No. 7,271,943). Accordingly, a correcting optical system including an f• lens or the like can be made compact and simple. Thus, such a mirror can be preferably used as a scanning device in a downsized low-cost image forming apparatus.

When the above-described oscillator with a characteristic resonance frequency is used, it may be impossible to appropriately use it unless the characteristic resonance frequency of the device is accurately recognized. In its connection, there is a possibility that an actual resonance frequency of the device deviates from a predetermined resonance frequency set at a design time due to tolerances of mechanical sizes, temperature and a change with time.

Furthermore, in conventional systems, when a MEMS mirror is installed, for example, in LBP and its resonance frequency is measured, the following phenomenon can occur. That is, the measured resonance frequency can shift from the characteristic resonance frequency due to oscillation fluctuation or non-periodical jitters caused by turbulence resulting from air resistance at the time of oscillating motion.

### SUMMARY OF THE INVENTION

According to one aspect, the present invention provides a movable body apparatus including an oscillatory system, a driving portion for driving the oscillatory system with a driving signal, a detecting portion for detecting the oscillating condition of the movable body, a storing portion for storing frequency characteristics, and an obtaining or detecting portion for obtaining a resonance frequency. The oscillatory system includes at least a movable body, and an elastic support portion, such as a torsion spring, for supporting the movable body in a swingingly rotatable manner. The storing portion stores data of frequency characteristics of maximum angular displacement based on maximum angular displacements of the movable body corresponding to plural driving frequencies. The maximum angular displacements of the movable body are detected by the detecting portion. The obtaining portion obtains the resonance frequency of the oscillatory system by fitting to the data of frequency characteristics of maximum angular displacement stored in the storing portion, using a least squares method.

According to another aspect, the present invention provides an optical deflector including the above-described movable body apparatus, in which an optical deflecting member, such as a reflective mirror, is disposed on the movable body, and in which a light beam incident on the optical deflecting member is deflected.

According to another aspect, the present invention provides an optical instrument, such as an image forming apparatus, including the above-described optical deflector, in which the optical deflector deflects a light beam from a light source, and in which at least a portion of the light beam is applied to a light irradiation object such as a photosensitive member.

According to yet another aspect, the present invention provides a resonance frequency detecting method of detecting a resonance frequency of an oscillatory system in a movable body apparatus including the oscillatory system with at least a movable body and an elastic support portion, and a driving portion for driving the oscillatory system with a driving signal, which includes at least the following steps. In a first step, maximum angular displacements of the movable body corresponding to plural driving frequencies are detected. In a second step, data of frequency characteristics of maximum angular displacement is stored based on the maximum angular displacements of the movable body corresponding to the plural driving frequencies. In a third step, the resonance frequency of the oscillatory system is obtained by fitting to the stored data of frequency characteristics of maximum angular displacement, using a least squares method.

According to the present invention, the resonance frequency of the movable body is obtained by a predicting calculation in which the fitting to the data of frequency characteristics of maximum angular displacement of the movable body, such as a MEMS mirror, is performed using the least squares method. In the predicting calculation, values of parameters for obtaining the resonance frequency are sought so that random noises are normally distributed for all data of the maximum angular displacements corresponding to the driving frequencies, for example. Accordingly, it is possible to reduce the influence of jitters, and accurately measure the characteristic resonance frequency of the device.

Further features of the present invention will become apparent from the following description of exemplary embodiments, with reference to the attached drawings.

### BRIEF DESCRIPTION OF THE DRAWINGS

FIG. 1 is a schematic perspective view illustrating an embodiment of the present invention including a laser light scanning mechanism, a BD sensor for measuring angular displacements of a MEMS mirror, and the like.

FIG. 2 is a block diagram illustrating a MEMS mirror driving portion in FIG. 1.

FIGS. 3A and 3B are graphs showing frequency characteristics of maximum angular displacement of a device having a resonance frequency.

FIG. 4 is a block diagram illustrating a resonance frequency detecting or obtaining portion in FIG. 2.

### DETAILED DESCRIPTION OF THE EMBODIMENTS

Embodiments of the present invention will hereinafter be described, with reference to the drawings.

A fundamental embodiment of the movable body apparatus of the present invention includes the above-described elements. The oscillatory system includes a structure for swingingly rotatably supporting a single movable body about a rotary axis to a support portion through an elastic support portion such as a torsion spring, or a structure for swingingly rotatably supporting plural movable bodies about a common rotary axis serially to a support portion through elastic support portions. The driving portion can receive a driving signal, and supply a driving force to the oscillatory system by electromagnetic method, electrostatic method, piezoelectric method, or the like. In the case of the electromagnetic drive, a permanent magnet is disposed on the movable body, and a coil for applying a magnetic field to the permanent magnet is arranged near the movable body, or vice versa, for example. In the case of the electrostatic drive, an electrode is arranged on the movable body, and another electrode is placed near the movable body so that an electrostatic force is generated between these electrodes. In the case of the piezoelectric drive, a piezoelectric element is disposed in the oscillatory system, or the support portion for the oscillatory system so that a driving force is applied to the oscillatory system.

The detecting portion detects a light beam defected and scanned by the movable body in the oscillatory system, or detects the angular displacement of the movable body, for example. More specifically, the detecting portion detects times at which the beam passes a predetermined scan position, or measures times at which the movable body swings by a predetermined angular displacement. When the movable body has an optical deflecting member on its surface to reflect and deflect a light beam from a light source, the light beam passes a light receiving device of the detecting portion twice within a single scan period. Accordingly, the driving signal can be generated and supplied to the driving portion based on the times at which the light beam passes the light receiving device.

The detecting portion can be anything that can detect the oscillating condition of the movable body, such as a piezoelectric element. For example, a piezoelectric sensor can be disposed in the elastic support portion. Alternatively, a capacitive sensor or magnetic sensor can be used. In the present invention, the detecting portion is constructed so that maximum angular displacements of the movable body corresponding to plural driving frequencies can be detected. The obtaining portion obtains the resonance frequency of the oscillatory system by the fitting method in which fitting to measured values (data of frequency characteristics of maximum angular displacement) is performed by changing parameters contained in a theoretical or empirical formula representing a model of the oscillatory system.

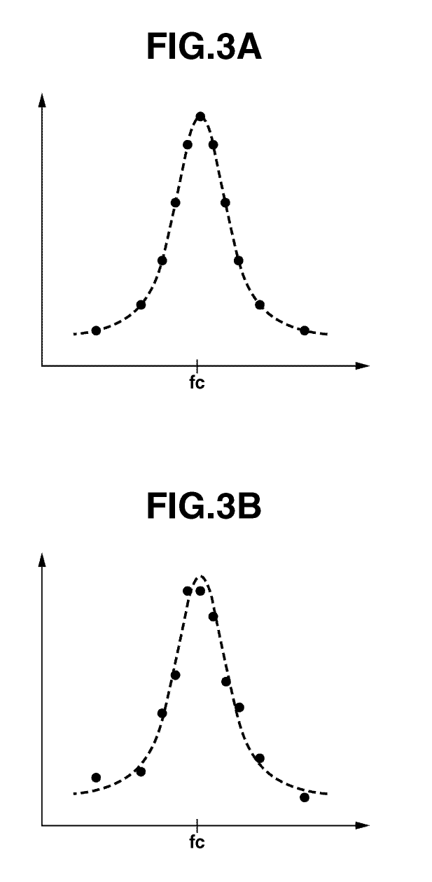

In the case of an image forming apparatus including the optical deflector in which the movable body has the optical deflecting member like a mirror, the movable body or MEMS mirror resonantly oscillates in a main scanning direction of the photosensitive member to scan the light beam in this direction, for example. In this case, the storing portion stores frequency characteristics of maximum angular displacement of the MEMS mirror corresponding to driving frequencies thereof. Here, starting from a frequency somewhat lower or higher than an approximately known resonance frequency, the frequency of a driving signal in the form of a sine wave, a pulse wave or the like is changed at appropriate intervals. The maximum angular displacement is detected at each driving frequency, and data is collected. The frequency changing interval can be set constant, or set narrower in a region where the maximum angular displacement largely changes, for example. The number of points of the driving frequency for acquisition of data is plural. For example, it is preferable to choose about ten points as illustrated in FIGS. 3A and 3B. When the oscillatory system has plural resonance frequencies to be obtained, data of frequency characteristics of maximum angular displacement needs to be obtained for each resonance frequency in the above-described manner.

The obtaining portion obtains the resonance frequency of the MEMS mirror from the frequency characteristics of maximum angular displacement stored in the storing portion. The driving portion drives the MEMS mirror based on the resonance frequency obtained by the obtaining portion. That is, the oscillatory system is driven with a sine-wave driving signal or the like generated based on the resonance frequency obtained by the obtaining portion. Thus, the driving portion applies the driving force of the above driving signal to the oscillatory system so that the oscillating condition detected by the detecting portion can reach a target condition. The oscillatory system can also be driven in a manner in which the driving portion applies a driving force of a driving signal with a driving frequency intentionally shifted from the resonance frequency a predetermined value. When the oscillatory system has plural resonance frequencies, the oscillatory system can be driven with, for example, a synthesized driving signal of plural sine-waves at frequencies close to the respective resonance frequencies.

In the case of an image forming apparatus, the detecting portion can be comprised of a BD (beam detector) signal detector which detects a BD signal of a printer engine, and a measuring portion which calculates the maximum angular displacement from the BD signal. The obtaining portion performs a predicting calculation of the resonance frequency based on data of frequency characteristics of maximum angular displacements at plural driving frequencies stored in the storing portion. For example, the resonance frequency of the oscillatory system is obtained by a method in which a theoretical formula of a lag system is fitted to the data of frequency characteristics of maximum angular displacement, using the least squares method. The order of the lag system is second or more that is one larger than the degree of freedom of the oscillatory system.

As described above, the movable body apparatus can be used as the optical deflector. In this case, the optical deflecting member is placed on at least a movable body in the movable body apparatus, and a light beam incident on the optical deflecting member is deflected. The optical deflector can be used in optical instruments such as the image forming apparatus. Here, the optical deflector deflects the light beam from the light source, and at least a portion of the light beam is applied to a light irradiation object such as the photosensitive member.

Further, a fundamental embodiment of the resonance frequency detecting method of the present invention is performed as described above.

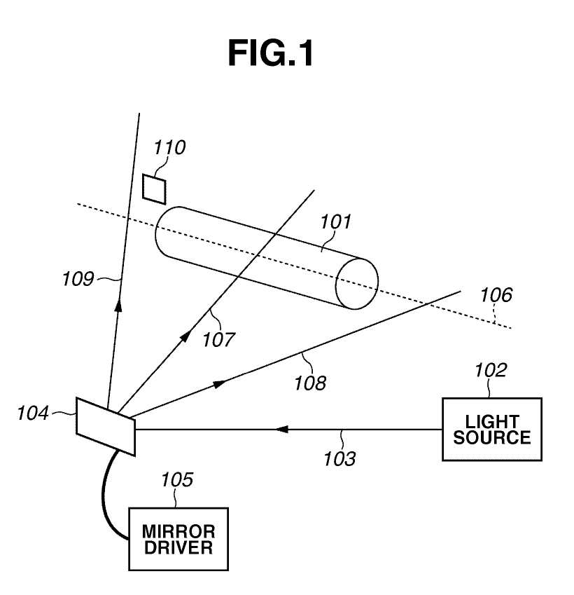

A first embodiment will be hereinafter described with reference to the drawings. FIG. 1 lillustrates the embodiment of an image forming apparatus including a movable body apparatus used as an optical deflector. This laser light scanning mechanism includes a BD sensor 110 for measuring the angular displacement of a MEMS mirror 104 of the optical deflector. In FIG. 1, reference numeral 101 designates a photosensitive member used as a light irradiation object, and reference numeral 102 designates a light source for emitting laser light 103. The MEMS mirror 104 of the movable body reflects and deflects the laser light 103, and a mirror driving portion 105 drives the MEMS mirror 104. The MEMS mirror 104 swingingly rotates about a rotary axis.

The laser light 103 scanned by the MEMS mirror 104 moves along a trace 106 on the photosensitive member 101. Reference numeral 107 designates a center scan position of the laser light 103 deflected by the mirror 104, and reference numerals 108 and 109 designate positions of the laser light 103 deflected by the maximum angular displacement. The BD sensor 110 is placed at a position through which the laser light 103 deflected by a predetermined angular displacement passes. The BD sensor 110 acts as a detector for detecting the maximum angular displacement of the laser light deflected by the mirror 104. The BD sensor 110 also acts as a detector that performs an ordinary function in the image forming apparatus. That is, the BD sensor 110 detects the timing for determining a starting point of modulation of the laser light 103 according to an image signal.

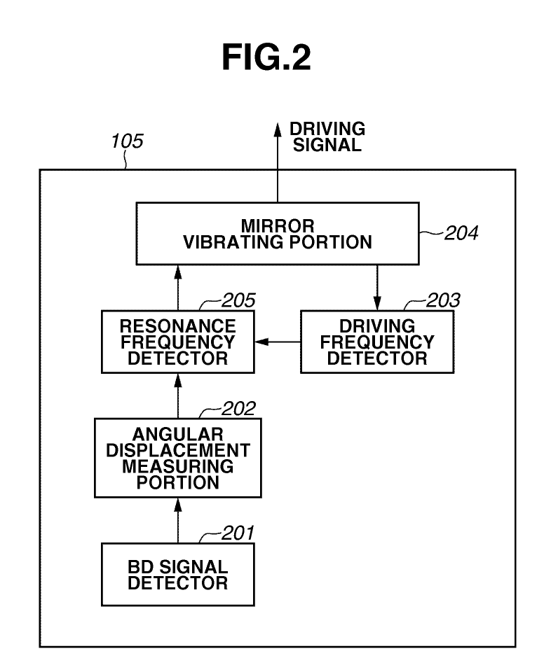

In FIG. 2 illustrating the structure of a mirror driving portion 105, reference numeral 201 designates a BD signal detecting portion for detecting the BD signal from the BD sensor 110, and reference numeral 202 designates an angular displacement measuring portion for measuring the maximum angular displacement of the MEMS mirror 104 based on the signal detected by the BD signal detecting portion 201. A driving frequency detecting portion 203 detects the mirror driving frequency from a mirror oscillating or vibrating portion 204 which supplies the driving signal to the driving portion for the mirror 104. A resonance frequency detecting portion 205 obtains the resonance frequency of the MEMS mirror 104 based on frequency characteristics of maximum angular displacement at each driving frequency obtained by the angular displacement measuring portion 202 and the driving frequency detecting portion 203. The mirror oscillating portion 204 determines the driving frequency of the driving signal based on the resonance frequency obtained by the resonance frequency detecting portion 205, and supplies the driving signal to the driving portion for the MEMS mirror 104.

Here, the oscillatory system includes a single movable body. Therefore, a theoretical formula of frequency characteristics of maximum angular displacement of the MEMS mirror 104 detected through the BD sensor 110 can be represented by the following formula (1) where |G(j•)|=G( •; •, •ₙ) is the gain of a transfer function for a general second order lag system, • is the frequency, • is the attenuation coefficient, and •ₙ is the resonance frequency parameter.

$$G ( ω ; ϛ , {ω}_{n} ) = \frac{1}{\sqrt{{( 1 - {( \frac{ω}{{ω}_{n}} )}^{2} )}^{2} + {( 2 ϛ \frac{ω}{{ω}_{n}} )}^{2}}} \qquad ( 1 )$$

The waveform of frequency characteristics of maximum angular displacement without any non-periodical jitters has a curve as illustrated in FIG. 3A, and FIG. 3B shows a model of the waveform with non-periodical jitters taken into consideration. As compared to the waveform model in FIG. 3A, the maximum angular displacement of the MEMS mirror 104 at each driving frequency randomly changes in the waveform model in FIG. 3B.

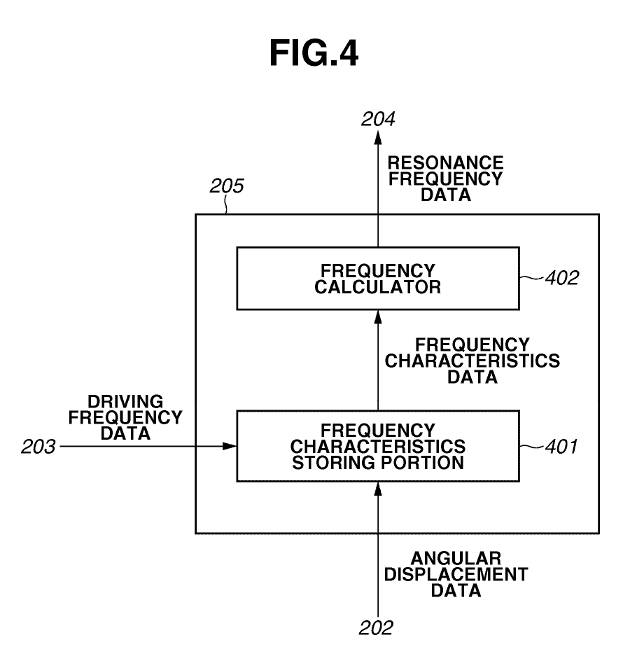

FIG. 4 illustrates the construction of the resonance frequency obtaining portion 205 shown in FIG. 2. A frequency characteristics storing portion 401 corresponds data of maximum angular displacements supplied from the angular displacement measuring portion 202 and data of driving frequencies supplied from the driving frequency detecting portion 203 to each other, and stores plotted data of frequency characteristics of maximum angular displacement of the MEMS mirror 104. The stored frequency characteristics data is supplied to a frequency calculating portion 402. The frequency calculating portion 402 performs the predicting calculation of the resonance frequency of the mirror 104 based on the frequency characteristics data supplied from the storing portion 401, and supplies the resonance frequency data to the mirror oscillating portion 204. The mirror oscillating portion 204 generates the driving signal based on the resonance frequency data, and supplies the driving signal to the driving portion to drive the MEMS mirror 104. The driving frequency can be approximately set at the resonance frequency, or at a frequency intentionally shifted from the resonance frequency.

The predicting calculation of the resonance frequency can be executed by curve-fitting to the frequency characteristics data, using the least squares method. More specifically, mean residual sum of squares Sₙ represented by the following formula (2) is calculated, where yᵢ is the plotted data set of maximum angular displacements at driving frequencies discrete in a frequency range as illustrated in FIGS. 3A and 3B, and G(•; •, •ₙ) is the function of formula (1) into which parameters •ₙ and • of certain initial values are substituted. The calculation is repeated by changing the parameters •ₙ and • repetitively, until the mean residual sum of squares Sₙ converges into a certain minimum value.

$${S}_{n} = \frac{1}{n} {\sum }_{i = 1}^{n} {( {y}_{i} - G ( ω ; ϛ , {ω}_{n} ) )}^{2} \qquad ( 2 )$$

The formula (1) is a non-linear function with parameters •ₙ and • in a square root sign. Therefore, it is necessary to use the algorithm of a non-linear least squares method as the algorithm for the repetitive calculation. Here, the Gauss-Newton method is used.

In the Gauss-Newton method, each parameter in the fitting formula is Taylor-expanded, and terms up to the first order term are picked out. Thus, the following approximate formulae (3-1) and (3-2) are obtained.

$$\begin{matrix}G ( ω ; ϛ , {ω}_{n} ) = G ( ω ; {ϛ}^{*} , {ω}_{n} ) + {( \frac{\partial G}{\partial ϛ} )}_{ϛ = {ϛ}^{*}} Δ {ϛ}^{*} & ( 3 \text{-} 1 ) \\ G ( ω ; ϛ , {ω}_{n} ) = G ( ω ; ϛ , {ω}_{n}^{*} ) + {( \frac{\partial G}{\partial {ω}_{n}} )}_{{ω}_{n} = {ω}_{n}^{*}} Δ {ω}_{n}^{*} & ( 3 \text{-} 2 )\end{matrix}$$

Formulae (3-1) and (3-2) are linear with respect to ••* and ••ₙ*. Hence, the least squares condition of the mean residual sum of squares Sₙ can be written as the following formulae (4-1) and (4-2).

$$\begin{matrix}{S}_{ϛ} ≡ \frac{1}{n} {\sum }_{i = 1}^{n} {( {y}_{i} - G ( ω ; {ϛ}^{*} , {ω}_{n} ) - {( \frac{\partial G}{\partial ϛ} )}_{ϛ = {ϛ}^{*}} Δ {ϛ}^{*} )}^{2} & ( 4 \text{-} 1 ) \\ {S}_{ω n} ≡ \frac{1}{n} {\sum }_{i = 1}^{n} {( {y}_{i} - G ( ω ; ϛ , {ω}_{n}^{*} ) - {( \frac{\partial G}{\partial ω} )}_{{ω}_{n} = {ω}_{n}^{*}} {Δω}_{n} * )}^{2} & ( 4 \text{-} 2 )\end{matrix}$$

Accordingly, starting from these formulae, ••* and ••ₙ* can be obtained exactly similarly to the linear least squares method. The following formulae (5-1) and (5-2) thus obtained satisfy the original least squares condition.

ζ=ζ*+Δζ* (5-1)

ωₙ=ωₙ*+Δωₙ* (5-2)

However, since the above formulae are approximate results acquired by the Taylor expansion, each parameter value actually obtained is approximate one. Therefore, the calculation is repeated until necessary calculation precision can be obtained.

The value of the parameter •ₙ for the resonance frequency of the MEMS mirror is obtained by the predicting calculation so that random noises are normally distributed for all data of the maximum angular displacement at each driving frequency. Accordingly, even if a change in the maximum angular displacement due to jitters appears, influence on the above acquisition of the resonance frequency is small. Hence, the detection error of the resonance frequency due to jitters of the MEMS mirror 104 can be reduced by a construction in which the predicting calculation is performed by the frequency calculating portion 402 based on the frequency characteristics data in the frequency characteristics storing portion 401 as illustrated in FIG. 4.

The operation of the image forming apparatus using the optical deflector as illustrated in FIG. 1 is performed in the following manner. The laser light 103 emitted from the laser light source 102 is intensity-modulated in a predetermined manner in synchronization with the timing of scanning of the light beam, and one-dimensionally scanned by the MEMS mirror 104. The deflected laser light forms an image on the photosensitive member 101 through a writing lens or the like. The photosensitive member 101 is uniformly charged by a charging unit (not shown), and an electrostatic latent image is formed on a light scan portion of the photosensitive member 101. A toner image is formed on an image portion of the electrostatic latent image by a developing unit (not shown). The toner image is transferred and fixed on a paper (not shown), for example. Thus, an image is formed on the paper. In the image forming apparatus using the above optical deflector capable of being driven at a frequency deemed to be the resonance frequency obtained with high precision in the above manner, image forming can be executed with high performance.

A second embodiment will be described. In the first embodiment, the Gauss-Newton method is used as the non-linear least squares algorithm for converging the mean residual sum of squares Sₙ into the minimum value. Other calculating algorithms, such as Newton method, pattern method and the like can also be used. The resonance frequency parameter •ₙ can also be prediction-calculated by fitting the above formula (1) to the data, using each of those algorithms.

A third embodiment will be described. In the first and second embodiments, the oscillatory system with one degree of freedom includes a single MEMS mirror (movable body). Therefore, the resonance frequency is prediction-calculated by fitting the above formula (1), which is the transfer function of a general second order lag system, to the frequency characteristics data.

The present invention can also be applied to an oscillatory system with plural degrees of freedom having plural movable bodies and plural characteristic oscillation modes. Using a theoretical formula for frequency characteristics of maximum angular displacement adapted in accordance with the plural degrees of freedom, the resonance frequency can be obtained by the fitting using the non-linear least squares method. For example, in the case of a system with two degrees of freedom, the resonance frequency can be calculated by fitting a transfer function of a general third order lag system to the frequency characteristics data.

Except as otherwise discussed herein, the various components shown in outline or in block form in the Figures are individually well known and their internal construction and operation are not critical either to the making or using, or to a description of the best mode of the invention.

This application claims the benefit of Japanese Patent Application No. 2008-173324, filed Jul. 2, 2008, which is hereby incorporated by reference herein in its entirety.

What is claimed is:

1. A movable body apparatus comprising:
an oscillatory system including at least a movable body, and an elastic support portion for supporting the movable body in a swingingly rotatable manner;
a driving portion for driving the oscillatory system with a driving signal;
a detecting portion for detecting an oscillating condition of the movable body;
a storing portion for storing data of frequency characteristics of maximum angular displacement based on maximum angular displacements of the movable body corresponding to plural driving frequencies, which are detected by the detecting portion; and
an obtaining portion for obtaining a resonance frequency of the oscillatory system by fitting to data of the frequency characteristics of maximum angular displacement stored in the storing portion, using a least squares method.

2. A movable body apparatus according to claim 1, wherein the driving portion drives the oscillatory system with the driving signal generated based on the resonance frequency obtained by the obtaining portion.

3. A movable body apparatus according to claim 1, wherein the detecting portion includes a BD signal detector for detecting a BD signal of a printer engine, and an angular displacement measuring portion for calculating the maximum angular displacement from the BD signal.

4. A movable body apparatus according to claim 1, wherein the obtaining portion obtains the resonance frequency of the oscillatory system by fitting a theoretical formula of a lag system to the data of the frequency characteristics of maximum angular displacement, using a least squares method.

5. An optical deflector comprising:
the movable body apparatus according to claim 1; and
an optical deflecting member disposed on the movable body, a light beam incident on the optical deflecting member being deflected.

6. An optical instrument comprising:
the optical deflector according to claim 5; and
a light irradiation object,
wherein the optical deflector deflects a light beam from a light source, and at least a portion of the light beam is applied to the light irradiation object.

7. A resonance frequency detecting method of detecting a resonance frequency of an oscillatory system in a movable body apparatus including the oscillatory system with a movable body and an elastic support portion, and a driving portion for driving the oscillatory system with a driving signal, the method comprising the steps of:
detecting maximum angular displacements of the movable body corresponding to plural driving frequencies;
storing data of frequency characteristics of maximum angular displacement based on the maximum angular displacements of the movable body corresponding to the plural driving frequencies; and
obtaining the resonance frequency of the oscillatory system by fitting to the stored data of frequency characteristics of maximum angular displacements, using a least squares method.
